(19) United States
(12) Patent Application Publication
(10) Pub. No.: US 2010/0199319 A1
(43) Pub. Date: Aug. 5, 2010

(54) METHOD AND SYSTEM FOR ESTABLISHING VOIP COMMUNCATION BY MEANS OF DIGITAL VIDEO BROADCASTING NETWORK

(76) Inventors: Yong Hua Lin, Beijing (CN); Xiang Dong Wang, Beijing (CN); Yu Yuan, Beijing (CN)

Correspondence Address: IBM CORPORATION, T.J. WATSON RESEARCH CENTER, P.O. BOX 218, YORKTOWN HEIGHTS, NY, 10598, US

(21) Appl. No.: 12/526,864

(22) PCT Filed: Feb. 12, 2008
(86) PCT No.: PCT/EP08/51659

§ 371 Date: Apr. 14, 2010

(30) Foreign Application Priority Data
Feb. 13, 2007 (CN) 200710005584.1

(51) Int. Cl. H04N 7/173

(52) U.S. Cl. 725/106

(57) ABSTRACT

The present invention discloses a method and system for establishing VoIP communication by means of digital video broadcasting network. The method comprises: a first terminal sending a VoIP call request to a source VoIP server to which the first terminal belongs, the VoIP call request containing an address of a second terminal; the source VoIP server forwarding the VoIP call request to a destination VoIP server to which the second terminal belongs; the first terminal or any one of VoIP servers in a forwarding path from the source VoIP server to the destination VoIP server forwarding the VoIP call request to a digital video broadcasting front-end server; the digital video broadcasting front-end server converting the VoIP call request into a call request modulated in digital video signals and broadcasting it within the digital video broadcasting network. The method and system for establishing VoIP communication by means of digital video broadcasting network according to the present invention can receive the VoIP call and accordingly establish the VoIP communication even if the terminal, for example a DVB/IP combo set-top-box, is disconnected to the IP network. Moreover, the present invention can be implemented conveniently and has lower cost.

### TECHNICAL FIELD OF THE INVENTION

The present invention relates to techniques of establishing VoIP (Voice over IP) communication, and specifically to a method, a system, a terminal, a VoIP server and a digital video broadcasting front-end server for establishing VoIP communication by means of digital video broadcasting network.

### BACKGROUND OF THE INVENTION

With the development of digital TV and IP TV, a digital video broadcasting (DVB)/IP combo set-top-box is provided to enable users to simultaneously enjoy services such as digital cable TV, Video on demand (VoD) and web surfing and so on. One application of the DVB/IP combo set-top-box is for VoIP communications via IP network as a VoIP telephone terminal.

In general, the process of establishing the VoIP communication between the terminals is as follows: a calling terminal sends a call request to a VoIP server to which it belongs, wherein the call request contains an address of a called terminal. If the VoIP server finds that the called terminal is not within its service coverage, it sends the call request via IP network to a VoIP server to which the called terminal belongs. When the call request reaches the VoIP server to which the called terminal belongs, this VoIP server sends the call request to the called terminal. And then, the called terminal generates a response message and sends it back to the calling terminal. Thus, the VoIP communication is established. However, the existing VoIP communication requires that both the calling and the called terminals must be online If the called terminal is offline, the VoIP communication cannot be established.

Currently, an Internet service provider (ISP) usually provides two kinds of service charge modes, i.e. “monthly fixed charge” mode and “online time based charge” mode. Users of “online time based charge” mode do not always connect the DVB/IP combo set-top-box to the IP network. As a result, when a user's terminal initiates a VoIP call to the DVB/IP combo set-top-box of the user of “online time based charge” mode via the IP network, the user's DVB/IP combo set-top box cannot receive the VoIP call because it is disconnected to the IP network.

### SUMMARY OF THE INVENTION

The present invention is provided to address the above technical problems. Its objectives include providing a method, a terminal, a VoIP server, a digital video broadcasting front-end server and a system for establishing VoIP communication by means of digital video broadcasting network. Even if the terminal such as the DVB/IP combo set-top-box is disconnected to the IP network, the VoIP call can be received so that the VoIP communication can be established. Moreover, the present invention can be implemented conveniently with lower cost.

According to one aspect of the present invention, it is provided that a method for establishing VoIP communication by means of digital video broadcasting network, comprising: a first terminal sending a VoIP call request to a source VoIP server to which the first terminal belongs, the VoIP call request containing an address of a second terminal; the source VoIP server forwarding the VoIP call request to a destination VoIP server to which the second terminal belongs; the first terminal or any one of VoIP servers in a forwarding path from the source VoIP server to the destination VoIP server forwarding the VoIP call request to a digital video broadcasting front-end server; the digital video broadcasting front-end server converting the VoIP call request into a call request modulated in digital video signals and broadcasting it within the digital video broadcasting network.

According to another aspect of the present invention, it is provided that a terminal comprising: a first receiving unit for receiving a call request broadcasted by a digital video broadcasting front-end server and determining whether the terminal is a called terminal based on an address contained in the call request; a second receiving unit for receiving a call request transmitted via IP network; an IP connection enabling controller for enabling an IP connection of the terminal when the terminal is determined as the called terminal and IP connection status of the terminal is offline to the IP network; and a responding unit for generating a response message to the call request.

According to another aspect of the present invention, it is provided that a VoIP server comprising: a call request receiving unit for receiving a VoIP call request; and a forwarding unit for forwarding the VoIP call request to a digital video broadcasting front-end server via IP network.

According to another aspect of the present invention, it is provided that a digital video broadcasting front-end server comprising: a call request receiving unit for receiving a VoIP call request from above VoIP server; a format conversion unit for converting the VoIP call request into a call request modulated in digital video signals; and a broadcasting unit for broadcasting the call request modulated in digital video signals within digital video broadcasting network.

According another aspect of the present invention, it is provided that a system for establishing VoIP communication by means of digital video broadcasting network comprising: at least two above terminals; at least one above VoIP server; and the above digital video broadcasting front-end server; wherein, the terminals, the VoIP server and the digital video broadcasting front-end server execute the above method for establishing VoIP communication by means of digital video broadcasting network.

### DESCRIPTION OF THE DRAWINGS

FIG. 1 is a flowchart of a method for establishing VoIP communication by means of digital video broadcasting network according to an embodiment of the present invention;

FIG. 2 is a schematic block diagram of a VoIP server according to an embodiment of the present invention;

FIG. 3 is a schematic block diagram of a digital video broadcasting front-end server according to an embodiment of the present invention;

FIG. 4 is a schematic block diagram of a terminal according to an embodiment of the present invention; and

FIG. 5 is a block diagram of a system for establishing VoIP communication by means of digital video broadcasting network according to an embodiment of the present invention.

### DETAILED DESCRIPTION OF THE INVENTION

It is believed that above and other objectives, features and advantages of the present invention will become more apparent with reference to the following detailed description of the specific embodiments of the present invention taken in conjunction with the drawings.

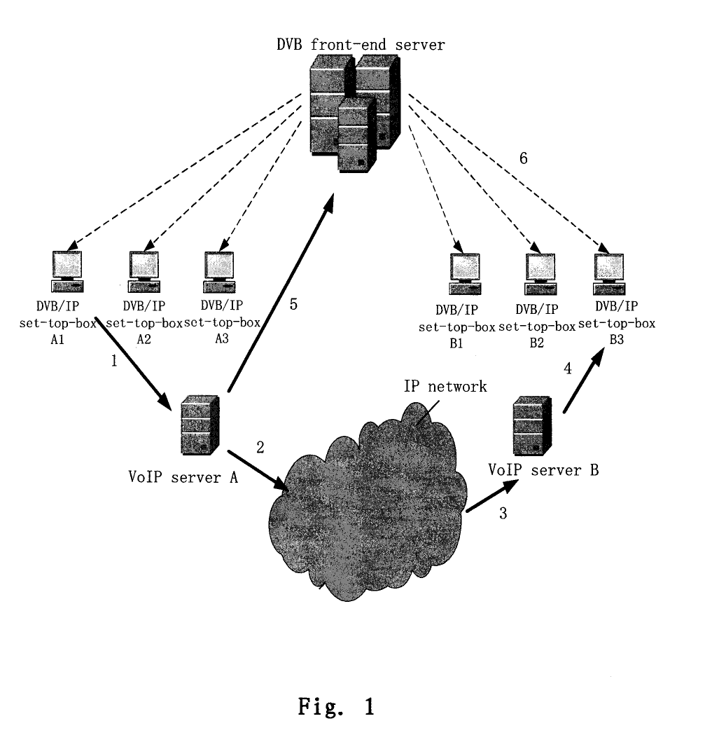

FIG. 1 is a flowchart of a method for establishing VoIP communication by means of digital video broadcasting network according to an embodiment of the present invention. FIG. 1 shows a typical DVB+IP environment.

In the DVB+IP environment shown in FIG. 1, a terminal is a DVB/IP combo set-top-box which can be connected to IP network to receive and send IP messages and which can be connected to a DVB front-end server to receive digital video broadcasting signals.

When the DVB/IP combo set-top-box A1 wants to establish VoIP communication with the DVB/IP combo set-top-box B3, the DVB/IP combo set-top-box A1 firstly sends a VoIP call request to the VoIP server A to which it belongs, as shown by solid arrow 1 in FIG. 1. The VoIP call request contains an address of the DVB/IP combo set-top-box B3. In another embodiment, the initiating party of the VoIP communication can also be a common IP telephone.

After receiving the call request, the VoIP sever A checks whether the DVB/IP combo set-top-box B3 is within its service coverage based on the address contained in the call request. If the VoIP server A does not provide services to the DVB/IP combo set-top-box B3, the VoIP server A forwards the call request via the IP network to the VoIP server B to which the DVB/IP combo set-top-box B3 belongs, as shown by solid arrows 2 and 3 in FIG. 1.

The VoIP server A also forwards the call request to the DVB front-end server in the digital video network via the IP network, as shown by solid arrow 5 in FIG. 1.

Alternatively, the VoIP server which forwards the VoIP call request to the DVB front end server can also be the VoIP server B, or any one of the VoIP servers in a forwarding path from the VoIP server A to the VoIP server B, or even the DVB/IP combo set-top-box A1 itself. In the later cases, when a certain VoIP server or the set-top-box itself forwards the call request to the DVB front-end server, the other VoIP servers or the set-top-box do not forward the request to the DVB front-end server.

In addition, the VoIP server A can also forward the VoIP call request to the DVB front-end server if it does not receive a response message within a pre-determined period after forwarding the call request to the VoIP server B.

In addition, the VoIP server B can also forward the call request to the DVB front-end server if it has not established an IP connection to the DVB/IP combo set-top-box B3 after receiving the call request.

When the DVB front-end server receives the VoIP call request, it converts the format of the call request to make the call request to be a call request modulated in digital video signals. And then, the DVB front-end server broadcasts the call request modulated in digital video signals to all DVB/IP combo set-top-boxes within the digital video broadcasting network via DVB downlinks, as shown by dashed arrow 6 in FIG. 1.

When the DVB/IP combo set-top-boxes receive the call request modulated in digital video signals, they check whether the address contained in the call request is their own address. If no, the call request is discarded, and if yes, it is indicated that the DVB/IP combo set-top-box which has the same address is the receiver of this call, and the further processing is executed. In this embodiment, the called terminal is the DVB/IP combo set-top-box B3.

Next, the DVB/IP combo set-top-box B3 checks whether it is connected to the IP network (accordingly can be connected to the VoIP server B). If the DVB/IP combo set-top-box B3 is disconnected to the IP network, it enables the connection to the IP network to be connected to the VoIP server B. In addition, the DVB/IP combo set-top-box B3 can also display the corresponding messages on a TV set connected thereto to facilitate the called user to view.

Next, the DVB/IP combo set-top-box B3 generates a response message and sends it back to the VoIP server B. The VoIP server B returns the response message to the VoIP server A via the IP network and the VoIP server A returns it to the DVB/IP combo set-top-box A1. Thus the VoIP voice communication is established between the DVB/IP combo set-top-boxes A1 and B3.

It can be seen from above description that in the method for establishing VoIP communication by means of digital video broadcasting network of this embodiment, the VoIP call request is forwarded via the DVB downlinks. Since the downlinks between the DVB front-end server and the DVB/IP combo set-top-boxes are always connected, it ensures that the VoIP communication between the DVB/IP combo set-top-boxes can be established at any time. Even if the DVB/IP combo set-top-box as the called terminal is disconnected to the IP network, the VoIP call can also be received. In addition, the DVB/IP combo set-top-box which is not connected to the IP network can automatically enable the connection to the IP network to respond to the VoIP call request by receiving the VoIP call request from the DVB front-end server.

In another embodiment, if the VoIP server B finds that the DVB/IP combo set-top-box B3 has been connected to the IP network after receiving the VoIP call request, it sends the call request to the DVB/IP combo set-top-box B3. At that time, the DVB/IP combo set-top-box B3 will receive two call requests, i.e. the broadcasted call request modulated in digital video signals from the DVB front-end server and the VoIP call request forwarded by the VoIP server B. In this case, the DVB/IP combo set-top-box B3 only selects either of the call requests, and then executes the subsequent processing. Preferably, the DVB/IP combo set-top-box B3 selects the VoIP call request.

Further, the DVB/IP combo set-top-box B3 can determine whether the received two call requests are originated from the same terminal, i.e. the DVB/IP combo set-top-box A1. If yes, the DVB/IP combo set-top-box B3 responds to either of the call requests and then executes the subsequent processing. If no, the DVB/IP combo set-top-box B3 selects either of the call requests. Preferably, the VoIP call request from the VoIP server B is selected, and another call request is maintained or discarded.

Further, if the DVB/IP combo set-top-box B3 is busy when receiving the call request, it maintains the selected call request for a pre-determined period. If the DVB/IP combo set-top-box B3 generates a response message within the pre-determined period, the subsequent processing is executed. If the DVB/IP combo set-top-box B3 has not generated any response when the pre-determined period has lapsed, it discards the selected call request and terminates the process of establishing the VoIP communication.

In addition, if the DVB/IP combo set-top-box B3 is busy when receiving the call request, it can discard the received two call requests directly and terminate the process of establishing the VoIP communication.

The further processing after the called terminal receives the call request is described above. The internal resource of the called terminal can be saved.

When the VoIP communication is established between the DVB/IP combo set-top-boxes A1 and B3, the users of the DVB/IP combo set-top-boxes A1 and B3 can have a VoIP voice conversation. When the voice conversation is terminated, the DVB/IP combo set-top-box B3 returns to the IP connection status before the voice conversation, i.e. if the DVB/IP combo set-top-box B3 is disconnected to the IP network before the voice conversion, when the voice conversation is terminated, the DVB/IP combo set-top-box B3 is automatically disconnected to the IP network.

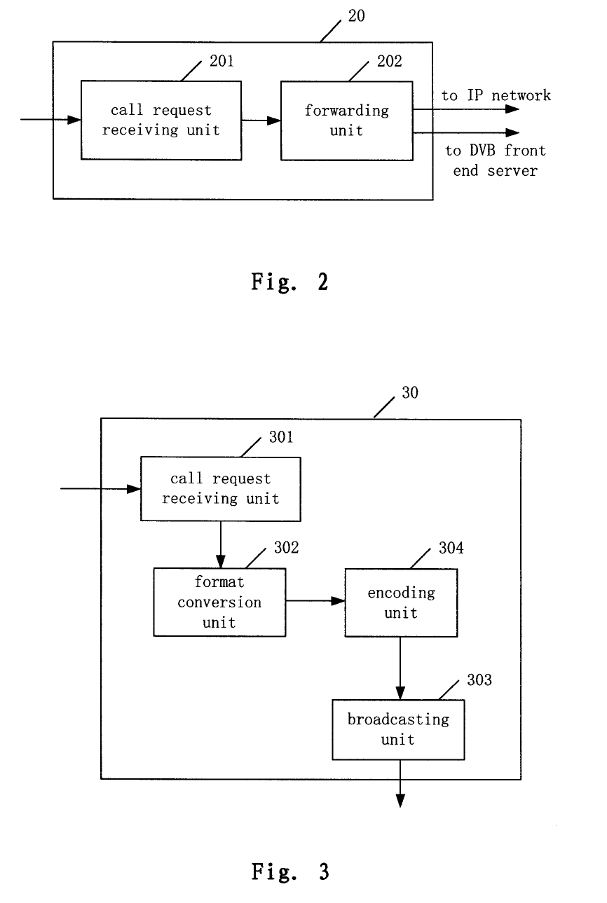

FIG. 2 is a schematic block diagram of a VoIP server 20 according to an embodiment of the present invention. This embodiment is described in details as below in conjunction with the drawing. The VoIP server 20 of this embodiment can be used in a system for establishing VoIP communication by means of digital video broadcasting network described later.

As shown in FIG. 2, the VoIP server 20 comprises: a call request receiving unit 201 which receives a VoIP call request from a terminal; and a forwarding unit 202 for forwarding the VoIP call request to another VoIP server or terminal and a DVB front-end sever via IP network.

In fact, the call request receiving unit 201 is known in the existing VoIP server, and the function of forwarding the call request to another VoIP server or terminal in the forwarding unit 202 is also known in the existing VoIP server. Thus, the VoIP server 20 of this embodiment can be implemented by adding the function of forwarding the call request to the DVB front-end server into the existing VoIP server.

It would be noticed that the VoIP server 20 and its components can be implemented by hardware circuit such as Very Large Scale Integrated Circuit or gate array, semiconductor such as logic chips and transistors, or programmable hardware device such as field programmable gate array, programmable logic device, and by software executed by various types of processors, and by the combination of the above hardware circuit and the software.

It can be seen from above description that the VoIP server of this embodiment adds the function of forwarding the call request to the DVB front end server into the original functions of the VoIP server and can forward the call request via the DVB front-end server when the call request cannot be forwarded to the terminal directly, so that the call request can reach the called terminal reliably.

FIG. 3 is a schematic block diagram of a digital video broadcasting front-end server 30 according to an embodiment of the present invention. This embodiment is described in details as below in conjunction with the drawing. The digital video broadcasting front-end server 30 of this embodiment can be used in a system for establishing VoIP communication by means of digital video broadcasting network described later.

As shown in FIG. 3, the DVB front-end server 30 of this embodiment comprises: a call request receiving unit 301 which receives a VoIP call request from the VoIP server 20 shown in FIG. 2; a format conversion unit 302 which converts the received VoIP call request into a call request modulated in digital video signals; and a broadcasting unit 303 for broadcasting the call request modulated in digital video signals within the digital video broadcast network.

Further, the DVB front-end server 30 of this embodiment comprises an encoding unit 304 which encodes the call request which is modulated in digital video signals and generated by the format conversion unit 302 into the digital video signals to broadcast.

It would be noticed that the DVB front-end server 30 and its components can be implemented by hardware circuit such as Very Large Scale Integrated Circuit or gate array, semiconductor such as logic chips and transistors, or programmable hardware device such as field programmable gate array, programmable logic device, and by software executed by various types of processors, and by the combination of the above hardware circuit and the software.

It can be seen from above description that the DVB front-end server of this embodiment can broadcast the VoIP call request within the digital video broadcast network and accordingly provide another path for forwarding the VoIP call request, so that the VoIP call request can arrive reliably.

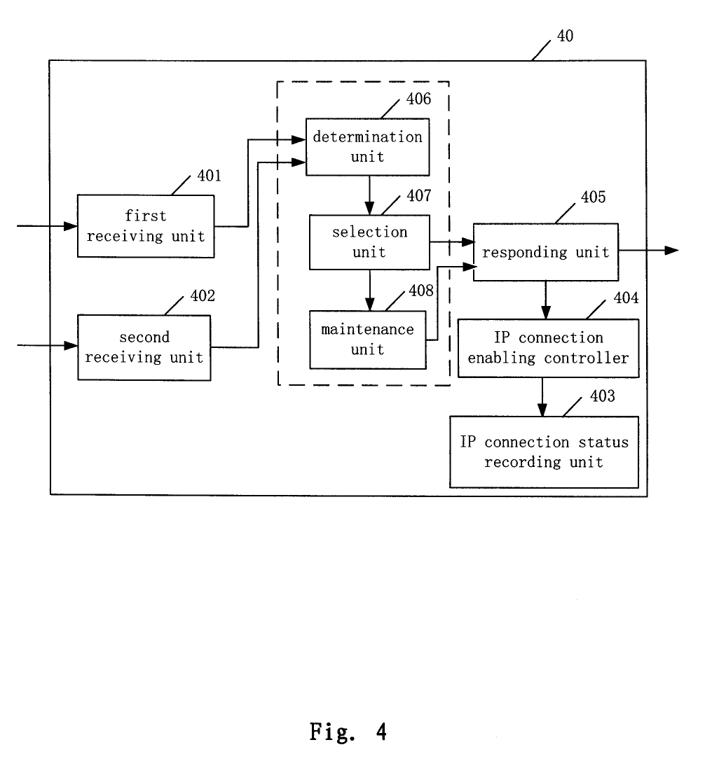

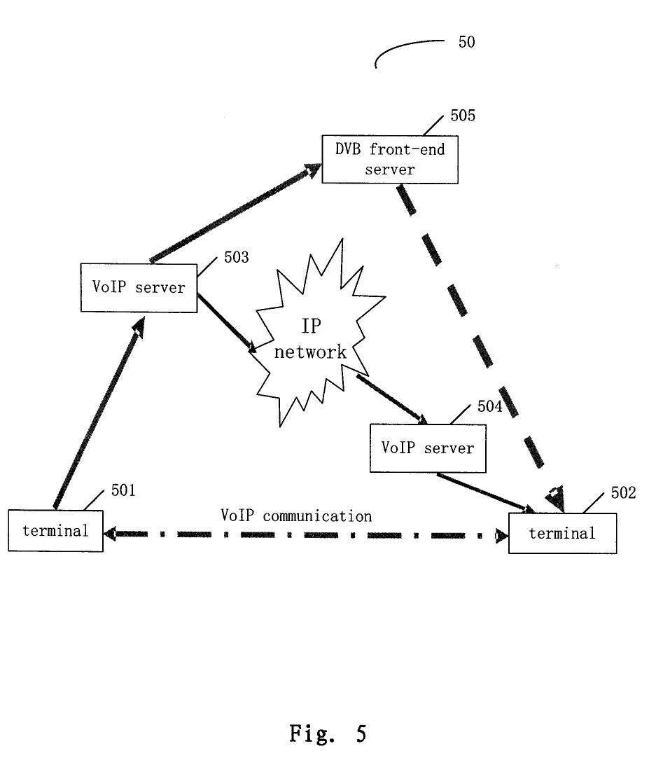

FIG. 4 is a schematic block diagram of a terminal 40 according to an embodiment of the present invention. This embodiment is described in details as below in conjunction with the drawing. The terminal 40 of this embodiment can be used in a system for establishing VoIP communication by means of digital video broadcast network described later.

As shown in FIG. 4, the terminal 40 of this embodiment comprises: a first receiving unit 401 which receives a call request broadcasted by the digital video broadcasting front-end server 30 shown in FIG. 3 and determines whether the terminal 40 is a called terminal based on an address contained in the call request; a second receiving unit 402 for receiving a call request transmitted via the IP network from the VoIP server 20 shown in FIG. 2; an IP connection enabling controller 404 for enabling an IP connection of the terminal 40 when the terminal 40 is determined as the called terminal and the IP connection status of the terminal 40 is offline to the IP network; and a responding unit 405 for generating a response message to the call request and returning it to the VoIP server 30.

Further, the terminal 40 of this embodiment comprises: an IP connection status recording unit 403 which records the IP connection status of the terminal 40; a determination unit 406 for determining whether the call request received by the first receiving unit 401 and the call request received by the second receiving unit 402 are originated from the same terminal; and a selection unit 407 for selecting either of the call requests according to the result of the determination unit 406.

In addition, the terminal 40 of this embodiment also comprises: a maintenance unit 408 for maintaining the call request selected by the selection unit 407 for a pre-determined period when the terminal 40 is busy. If the responding unit 405 has not generated any response message when the pre-determined period has lapsed, the call request would be discarded.

Preferably, the terminal 40 of this embodiment is a digital video broadcasting/IP combo set-top-box.

It is noticed that the terminal 40 and its components can be implemented by hardware circuit such as Very Large Scale Integrated Circuit or gate array, semiconductor such as logic chips and transistors, or programmable hardware device such as field programmable gate array, programmable logic device, and by software executed by various types of processors, and by the combination of the above hardware circuit and the software.

It can be seen from above description that even if the terminal of this embodiment is disconnected to the IP network, the terminal can also receive the VoIP call requests from other terminals in time and automatically enable the connection to the IP network. In addition, the terminal of this embodiment can further deal with the received requests to save the resource of the terminal.

Under the same inventive concept, FIG. 5 is a block diagram of a system for establishing VoIP communication by means of digital video broadcasting network according to an embodiment of the present invention. This embodiment is described in details as below in conjunction with the drawing.

As shown in FIG. 5, the system 500 for establishing VoIP communication by means of digital video broadcasting network of this embodiment comprises: terminals 501 and 502 which are the terminals shown in FIG. 4; VoIP servers 503 and 504 which are the VoIP servers shown in FIG. 2; and the DVB front-end server 505 which is the DVB front-end server shown in FIG. 3. In order to facilitate the description, it is assumed that the VoIP server 503 provides IP services to the terminal 501 and the VoIP server 504 provides IP services to the terminal 502. Of course, the terminals 501 and 502 can also be provided with the services by the same VoIP server.

If the terminal 501 wants to establish VoIP communication with the terminal 502, the terminal 501 sends a VoIP call request to the VoIP server 503. The VoIP call request contains an address of the terminal 502. The VoIP server 503 receives the VoIP call request and finds that a called terminal of the VoIP call request is not within its service coverage, and then it forwards the VoIP call request to the VoIP server 504 via IP network and forwards the VoIP call request to the DVB front-end server 505 via the IP network. The DVB front-end server 505 performs format conversion on the VoIP call request, and generates a call request modulated in digital video signals, and then broadcasts it within the digital video broadcasting network. The terminal 502 receives the call request modulated in digital video signals via DVB downlinks and finds itself is the called terminal. As a result, the terminal 502 enables the connection to the IP network, and generates a response message, and then sends the message to the VoIP server 504. The response message is sent back to the VoIP server 503 from the VoIP server 504 via the IP network and finally arrives at the terminal 501. Thus, the VoIP communication between the terminals 501 and 502 is established.

The system 500 for establishing VoIP communication by means of digital video broadcasting network of this embodiment can operationally implement the method for establishing VoIP communication by means of digital video broadcasting network of the embodiment shown in FIG. 1.

Although the method and system for establishing VoIP communication by means of digital video broadcasting network are described in detail accompanying with the specified embodiments in the above, the present invention is not limited as above. It should be understood for persons skilled in the art that the above embodiments may be varied, replaced or modified without departing from the spirit and the scope of the present invention.

1. A method for establishing a voice over internet protocol (VoIP) communication by means of a digital video broadcasting network, the method comprising:
sending a VoIP call request from a first terminal to a source VoIP server to which the first terminal belongs, wherein the VoIP call request contains an address of a second terminal;
forwarding the VoIP call request from the source VoIP server to a destination VoIP server to which the second terminal belongs;
forwarding the VoIP call request to a digital
video broadcasting front-end server from the first terminal or any one of VoIP servers in a forwarding path from the source VoIP server to the destination VoIP server; and
converting the VoIP call request into a call request modulated in digital video signals by the digital video broadcasting front-end server and broadcasting the call request modulated in digital video signals within the digital video broadcasting network.

2. The method of claim 1, further comprising:
receiving the call request modulated in digital video signals by the second terminal;
determining whether the second terminal is a called terminal based on the address contained in the received VoIP call request by the second terminal; and
establishing a connection to an internet protocol (IP) network by the second terminal if the second terminal determines the second terminal is the called terminal.

3. The method of claim 1, wherein the VoIP server which forwards the VoIP call request to the digital video broadcasting front-end server is the source VoIP server.

4. The method of claim 1, wherein the VoIP server which forwards the VoIP call request to the digital video broadcasting front end server is the destination VoIP server.

5. The method of claim 1-4, further comprising:
encoding and modulating the call request into the digital video signals to broadcast by the digital video broadcasting front-end server.

6. The method of claim 1, further comprising:
forwarding the VoIP call request to the second terminal by the destination VoIP server if the second terminal has been connected to the IP network; and
selecting either of the received call requests by the second terminal.

7. The method of claim 6, further comprising:
maintaining the selected call request for a pre-determined period if the second terminal is busy; and
discarding the selected call request by the second terminal if the second terminal has not generated any a response message when the pre-determined period has lapsed.

8. The method of claim 1, further comprising:
returning to the IP connection status by the second terminal before the voice conversation when a voice conversation between the first and second terminals is terminated.

9. A voice over internet protocol (VoIP) server for establishing a VoIP communication by means of a digital video broadcasting network, the VoIP server comprising:
a call request receiving unit for receiving a VoIP call request; and
a forwarding unit for forwarding the VoIP call request to a digital video broadcasting front-end server by means of an internet protocol (IP) network.

10. A digital video broadcasting front-end server for establishing a voice over internet protocol (VoIP) communication by means of a digital video broadcasting network, the digital video broadcasting front-end server comprising:
a call request receiving unit for receiving a VoIP call request from a VoIP server;
a format conversion unit for converting the VoIP call request into a call request modulated in digital video signals; and
a broadcasting unit for broadcasting the call request modulated in digital video signals within the digital video broadcasting network.

11. A terminal for establishing a voice over internet protocol (VoIP) communication by means of digital video broadcasting network, the terminal comprising:
a first receiving unit for receiving a call request broadcasted by a digital video broadcasting front-end server and determining whether the terminal is a called terminal based on an address contained in the call request;
a second receiving unit for receiving a call request transmitted via an internet protocol (IP) network;
an IP connection enabling a controller for enabling an IP connection of the terminal when the terminal is determined as the called terminal and its IP connection status is offline to the IP network; and
a responding unit for generating a response message to the call request.

12. The terminal of claim 11, further comprising:
a determination unit for determining whether the call request received by the first receiving unit and the call request received by the second receiving unit are originated from the same terminal; and
a selection unit for selecting either of the call request according to the determination result of the determination unit.

13. The terminal of claim 11, wherein the terminal is a digital video broadcasting 1IP combo set-top-box.

14. (canceled)

15. The method of claim 3, further comprising:
forwarding the VoIP call request to the digital video broadcasting front-end server by the source VoIP server if the source VoIP server receives no response message for a pre-determined period after forwarding the VoIP call request to the destination VoIP server.

16. The method of claim 4, further comprising:
forwarding the VoIP call request to the digital video broadcasting front-end server by the destination VoIP server if the destination VoIP server finds that the destination VoIP server has not established an IP connection to the second terminal after receiving the VoIP call request.

17. The method of claim 6, further comprising:
determining whether the two call requests received are originated from the same terminal by the second terminal; and
selecting either call request according to a determination result by the second terminal.

18. The method of claim 8, wherein the second terminal is a combination of a digital video broadcasting set-top-box and IP set-top-box.

19. The digital video broadcasting front-end server of claim 10, further comprising:
an encoding unit for encoding the call request generated by the format conversion unit into the digital video signals.

20. The terminal of claim 12, further comprising:
a maintenance unit for maintaining the call request selected by the selection unit for a pre-determined period if the terminal is busy.
